(19) United States
(12) Patent Application Publication
(10) Pub. No.: US 2011/0316208 A1
(43) Pub. Date: Dec. 29, 2011

(54) In-line tensioning and shock absorbing device

(76) Inventor: Jeffrey D. Hancock, Uintah, UT (US)

(21) Appl. No.: 12/798,677

(22) Filed: Apr. 9, 2010

Related U.S. Application Data
(60) Provisional application No. 61/212,394, filed on Apr. 10, 2009.

(51) Int. Cl. F16F 7/00

(52) U.S. Cl. 267/141

(57) ABSTRACT

An in-line tensioning and shock absorbing device that is easily incorporated onto existing tie downs, including but not limited to straps, ropes, chains, cables and belts, used for securing cargo into a means of transportation and limits or prevents the application of dynamic forces to the tie down that result from the movement of the transportation means to which the tie down is secured.

### CROSS REFERENCE TO RELATED APPLICATION

This application claims the benefit of U.S. Provisional Application Ser. No. 61/212,394 filed Apr. 10, 2009 by Jeffrey D. Hancock and Dennis H. Hancock.

### FIELD OF THE INVENTION

The present invention relates generally to a means for securing loads subjected to dynamic forces.

### BACKGROUND OF THE INVENTION

Typically, to secure something that will be subjected to dynamic forces like carrying a load in a means of transportation, people have used tie downs such as straps, ropes, chains, cables and/or belts. When dynamic forces such as road vibrations cause the load to settle and shift, tie downs commonly lose their original tension. This slack can cause the tie downs to lose their attachment and/or break. If a tie down fails, it allows a shift in the load and can cause the means of transportation to become unstable. It can also allow the entire load to be lost. While some have attempted to incorporate varied tensioning devices into existing tie downs, those attempts have fallen short as the tensioning device is made part of the end of the tie down and are not incorporated into the tie down itself. The weaknesses with the tie down itself remain. There is therefore a need for a new type of tie down in-line tensioning and shock absorbing device that permits the user to change the amount of tension in the tie down simply and quickly in order to secure many different types of loads and to limit the impact that dynamic forces have on a load.

### SUMMARY OF THE INVENTION

To solve the problems with existing tie downs, we have designed an improved in-line tensioning shock absorbing device. The invention incorporates a single piece of material that can be retrofitted into an existing tie down, including but not limited to, straps, ropes, chains, cables and belts, and permits the user to secure a load to the means of transportation in which it is being carried with varying amounts of tension, while at the same time providing shock absorbing qualities that minimize the strain put on the tie down itself. The in-line tensioning shock absorbing device of the present invention can be incorporated into an existing tie down, by weaving the tie down through the openings in the device. Tension in the in-line tensioning shock absorbing device can be varied by the way in which the user threads the tie down through the in-line tensioning shock absorbing device. When in place, the in-line tensioning shock absorbing device provides dynamic compensation to movements of the tie down through tensioning while at the same time providing shock absorbing qualities that prohibit excess shifts in the load from overstressing the tie down. The in-line tensioning shock absorbing device can be made out of any number of flexible materials and can be used with any tie down on any means of transportation. A strap keeper can also be added to the device to permit the user to wrap a tie down around the device when it is not in use.

In one aspect of the invention, it provides an in-line tensioning shock absorbing device for securing loads in a means of transportation.

In another aspect of the invention, it provides an in-line tensioning shock absorbing device that prevents a load from shifting and overstressing the means by which it was secured.

In another aspect of the invention, it provides a means for providing varied tension when securing a load.

In another aspect of the invention, it provides a means for absorbing the shock associated with a shifting load.

In another aspect of the invention, it provides a means for conveniently storing a tie down when not in use.

To the accomplishment of the above and related aspects, the invention may be embodied in the form illustrated in the accompanying drawings. The drawings, however, are illustrative only. Variations are contemplated as being part of the invention, limited only by the scope of the claims.

### BRIEF DESCRIPTION OF THE DRAWINGS

FIG. 1 is a perspective view of our in-line tensioning shock absorbing device.

FIG. 2 is a side view of our in-line tensioning shock absorbing device.

FIG. 3 is a top view of our in-line tensioning shock absorbing device.

FIG. 4 is a perspective of our in-line tensioning shock absorbing device with strap keeper added.

### DETAILED DESCRIPTION OF THE INVENTION

In transporting cargo aboard a truck, tractor trailer, ship, airplane, railroad car or other means of transport, it is necessary to tie the cargo down to the supporting surface upon which it rests in order to avoid shifting of the cargo due to dynamic forces resulting from the movement of the transport means. This can be done by attaching a tie down or a plurality of tie downs between the cargo and appropriate cleats, brackets or other attachment means rigidly fixed to the supporting surface of the transport means. The tie-downs are tensioned to rigidly fix the cargo with respect to the supporting surface upon which it rests and thus prevent the cargo from shifting its position due to forces exerted thereon during starting, stopping or other movement of the transport means.

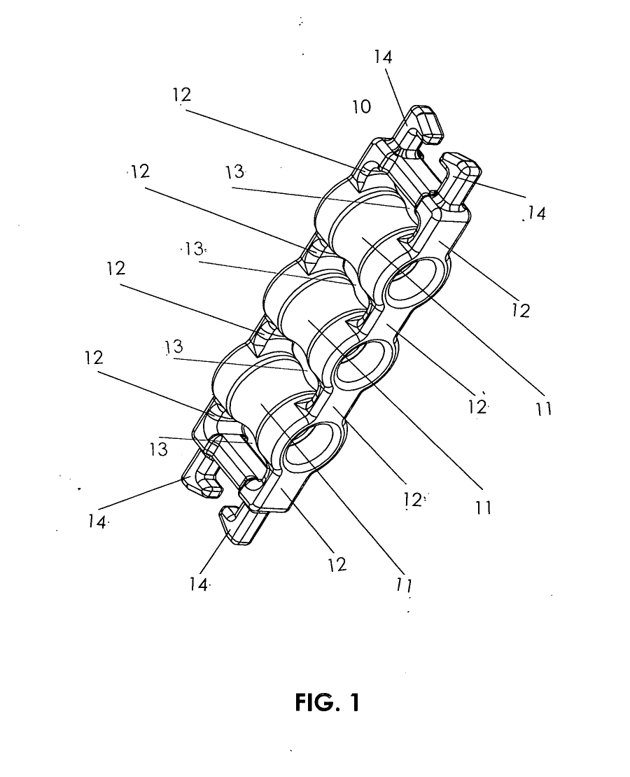

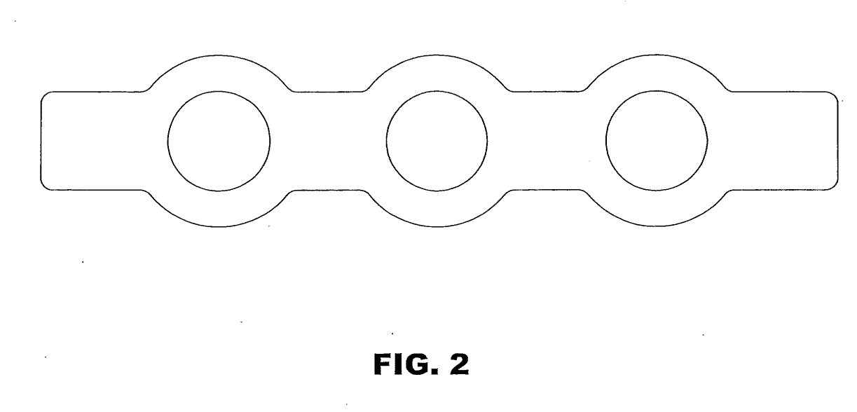

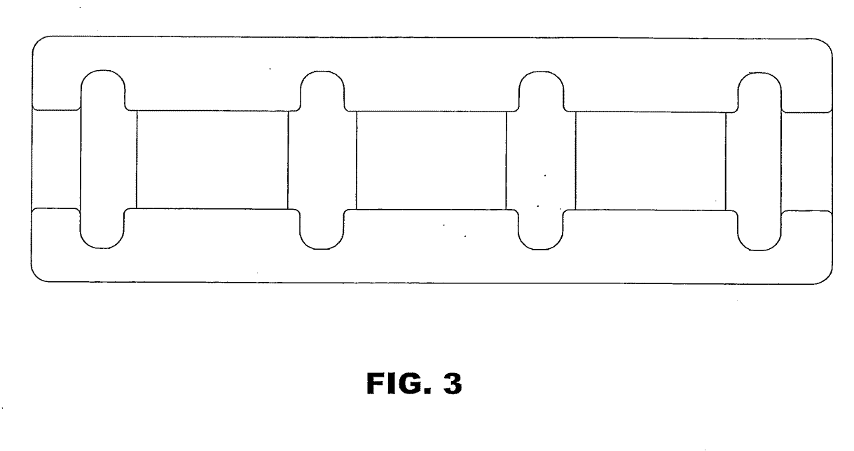

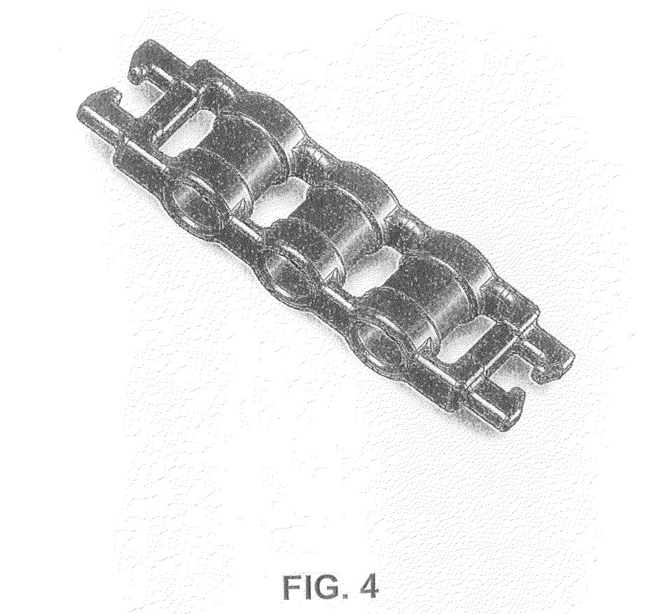

A preferred embodiment of the in-line tensioning and shock absorbing device 10 disclosed herein is shown in FIGS. 1-4. Broadly, the in-line tensioning and shock absorbing device 10 of this invention comprises one or more compression sections 11 and one or more stretching sections 12. A tie down 15 is threaded through tie down openings 13 to incorporate in-line tensioning and shock absorbing device. 10 on to the existing tie down 15.

One end of the existing tie down is secured to the transportation means. The tie down 15 is threaded through in-line tensioning and shock absorbing device 10 and then over the cargo or load that is to be secured to the transportation means with the other end of the tie down also being secured to the transportation means. The user of in-line tensioning and shock absorbing device 10 can vary the tension of the device in the way they thread the tie down 15 through in-line tensioning and shock absorbing device 10. By skipping one or more tie down openings 13, the tension of in-line tensioning and shock absorbing device 10 is reduced.

Once in-line tensioning and shock absorbing device 10 is incorporated on to a tie down, compression sections 11 and stretching sections 12 regulate the dynamic forces to which the tie down is subject during transportation. When a dynamic force is applied to the tie down, compression sections 11 compress and stretching sections 12 stretch at the same time to maintain the original tension in the tie down as was originally set by the user. Compression sections 11 and stretching sections 12 change in such a way as to transfer the shape of the tie down to in-line tensioning and shock absorbing device 10. Because in-line tensioning and shock absorbing device 10 is made out of flexible material, at the same time it is maintaining the tension on the tie down, it is also absorbing any shock that is applied to the tie down. Compression sections 11 and stretching sections 12 thus work simultaneously to maintain the tension in the tie down and absorb shock to the tie down.

When in-line tensioning and shock absorbing device 10 is not in use, a tie down may be wrapped around the device using tie down keepers 14 to hold the tie down in place around in-line tensioning and shock absorbing device 10 and prevent any tangling of the tie down with itself or other tie downs.

The in-line tensioning and shock absorbing device 10 can be made in various sizes to be used in applications as small as a backpack strap or as large as cargo tie downs on a container ship. There is essentially no limit to the size of the tie down to which in-line tensioning and shock absorbing device 10 can be applied. It can be made out of a variety of flexible materials and have a variety of compression sections 11 and stretching sections 12. In addition, because it can be made in a variety of sizes it can also be used with a variety of shapes and sizes of tie downs.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention.

What is claimed is:

1. An in-line tensioning and shock absorbing device comprising:
a compression section;
a stretching section; and
means by which the in-line tensioning and shock absorbing device can be incorporated on to a tie down.

2. The in-line tensioning and shock absorbing device of claim 1 wherein there are a plurality of compression sections and a plurality of stretching sections.

3. The in-line tensioning and shock absorbing device of claim 1 wherein the device is made of flexible material.

4. An in-line tensioning and shock absorbing device comprising:
a compression section;
a stretching section;
means by which the in-line tensioning and shock absorbing device can be incorporated on to a tie down; and
means by which a tie down can be secured around the device when not in use.

5. The in-line tensioning and shock absorbing device of claim 2 wherein there are a plurality of compression sections and a plurality of stretching sections.
